(19) United States
(12) Patent Application Publication
(10) Pub. No.: US 2016/0071108 A1
(43) Pub. Date: Mar. 10, 2016

(54) ENHANCED AUTOMATED ANTI-FRAUD AND ANTI-MONEY-LAUNDERING PAYMENT SYSTEM

(71) Applicant: IDM Global, Inc., Palo Alto, CA (US)

(72) Inventors: Jose Caldera, Palo Alto, CA (US); Joseph M. Hain, Redwood City, CA (US); Kieran Sherlock, Palo Alto, CA (US)

(73) Assignee: IDM Global, Inc., Palo Alto, CA (US)

(21) Appl. No.: 14/846,169

(22) Filed: Sep. 4, 2015

Related U.S. Application Data
(60) Provisional application No. 62/045,777, filed on Sep. 4, 2014.

(51) Int. Cl. G06Q 20/40

(52) U.S. Cl. CPC G06Q 20/4016; G06Q 2220/00

(57) ABSTRACT

A computerized anti-money-laundering and anti-fraud transaction analysis system may include a computerized cryptocurrency analysis tool system operatively coupled over a computerized network to a cryptocurrency exchange, a cryptocurrency exchange ledger and/or a know-your-customer facility. The computerized cryptocurrency analysis tool may include an automated payment cluster analysis routine for analyzing transaction data for a plurality of proposed cryptocurrency transactions. The transaction data for the plurality of proposed cryptocurrency transactions may be obtained from the cryptocurrency exchange, cryptocurrency ledger and/or the know-your-customer facility. The automated payment cluster analysis routine automatically identifies a cluster of related transactions in the plurality of proposed cryptocurrency transactions based upon an analysis of a plurality of transaction data items associated with each of the proposed cryptocurrency transactions. The computerized cryptocurrency analysis tool may also include automated summary routine for flagging a first transaction in the identified cluster as potentially associated with at fraud and/or money-laundering.

### CROSS REFERENCE TO RELATED APPLICATIONS

The current application claims the benefit of U.S. Provisional Application Ser. No. 62/045,777, filed Sep. 4, 2014, the disclosure of which is incorporated herein by reference.

### DEFINITIONS

Cryptocurrency. A cryptocurrency is a medium of exchange designed around securely exchanging information over a computerized network, which is a process made possible by certain principles of cryptography. The first cryptocurrency to begin trading was Bitcoin in 2009. Since then, numerous cryptocurrencies have been created. Fundamentally, cryptocurrencies are specifications regarding the use of currency which seek to incorporate principles of cryptography to implement a distributed, decentralized and secure information economy.

Bitcoin. Bitcoin is a peer-to-peer payment system introduced as open-source software in 2009 by developer Satoshi Nakamoto. The payments in the system are recorded in a public ledger using its own unit of account, which is also called Bitcoin. The Bitcoin system has no central repository and no single administrator, which has led the US Treasury to call Bitcoin a decentralized virtual currency. Although its status as a currency is disputed, media reports often refer to Bitcoin as a cryptocurrency or digital currency.

FIAT money. FIAT money is money which derives its value from government regulation or law. It differs from commodity money, which is based on a good, often a precious metal such gold or silver, which has uses other than as a medium of exchange. The term derives from the Latin fiat (“let it be done”, “it shall be”).

### BACKGROUND

Bitcoin transactions are by definition pseudo-anonymous. This means that fundamentally two users can transfer Bitcoins to each other without revealing the identity of either of them. Instead the transaction is cryptographically signed to ensure that the transaction took place, and there is a public record of such transaction that can be verified by all players on the Bitcoin infrastructure.

If either of these users wanted to exchange their Bitcoins to FIAT currency (or FIAT money) they would have to use a Bitcoin Exchange or a Bitcoin Wallet-hosting company that enables exchanging Bitcoins into FIAT currency.

In the United States, and other countries, governmental bodies regulate this exchange. In these countries, Bitcoin Exchanges are required by law to capture information about the users, usually encompassed within an activity known as “Know Your Customer” or KYC. Furthermore organizations/individuals that enable exchanging Bitcoins for FIAT currency, and vice versa are also required to monitor “financial” transactions for potential money laundering activity. Problems arising out of this new cryptocurrency technology operating over a global computer network include challenges of auditing the exchanging of Bitcoins and other cryptocurrencies into one another and also into (or between) so-called FIAT money or FIAT currency (https://en.wikipedia.org/wiki/Fiat_money) and vice versa for compliance with anti-money laundering and suspicious activity, such as fraud.

### SUMMARY

The current disclosure pertains to a transaction monitoring and KYC technology specifically addressing the challenges of auditing the exchanging of Bitcoins and other cryptocurrencies into one another and also into (or between) so-called FIAT money or FIAT currency and vice versa for compliance with anti-money laundering and suspicious activity. Embodiments of the current disclosure may be used by Bitcoin and other cryptocurrency exchanges to unveil suspicious activities associated to laundering money and potentially identify the actors as well as other related attributes involved with the transactions.

A computerized anti-money-laundering and anti-fraud transaction analysis system is provided that may include a computerized cryptocurrency analysis tool system operatively coupled over a computerized network to a cryptocurrency exchange, a cryptocurrency exchange ledger and/or a know-your-customer facility. The computerized cryptocurrency analysis tool may include an automated payment cluster analysis routine for analyzing transaction data for a plurality of proposed cryptocurrency transactions. The transaction data for the plurality of proposed cryptocurrency transactions may be obtained from the cryptocurrency exchange, cryptocurrency ledger and/or the know-your-customer facility. The automated payment cluster analysis routine automatically identifies a cluster of related transactions in the plurality of proposed cryptocurrency transactions based upon an analysis of a plurality of transaction data items associated with each of the proposed cryptocurrency transactions. The computerized cryptocurrency analysis tool may also include automated summary routine for flagging a first transaction in the identified cluster as potentially associated with at fraud and/or money-laundering upon at least one of: (a) determining at least one of the transaction data items in the cluster of related transactions is contained on a blacklist, (b) determining that at least one of the transaction data items in the cluster of related transactions is contained on a suspicious list and a transaction cryptocurrency amount is over a predetermined threshold, (c) determining that at least one of the transaction data items in the cluster of related transactions is contained on a suspicious list and a number of connections between the cluster of related transactions is over a predetermined threshold, and (d) determining that at least one of the transaction data items in the cluster of related transactions is contained on a suspicious list and a number of cryptocurrency transfers associated with the cluster of related transactions is over a predetermined threshold.

In a more detailed embodiment, the automated summary routine flags a second transaction as accepted based upon (x) determining that none of the transaction data items in the cluster of related transactions is contained on either of a blacklist and a suspicious list, (b) determining that the transaction cryptocurrency amount is under a predetermined threshold, and/or (c) determining that the number of connections between the cluster of related transactions is under a predetermined threshold. In yet a further detailed embodiment, the summary routine flags a third transaction for manual review upon not being flagged as potentially associated with money-laundering, upon not being flagged as potentially associated with fraud, and upon not being flagged as accepted.

Alternatively, or in addition, the blacklist contains known bad electronic addresses, known bad phone numbers, and/or known bad device identifiers.

Alternatively, or in addition, the transaction data for the plurality of proposed cryptocurrency transactions is obtained from a combination of the cryptocurrency exchange, the cryptocurrency ledger and the know-your-customer facility. Alternatively, or in addition, the transaction data for the plurality of proposed cryptocurrency transactions is obtained from a plurality of cryptocurrency exchanges.

Alternatively, or in addition, the automated payment cluster analysis routine automatically identifies a cluster of related transactions in the plurality of proposed cryptocurrency transactions based upon an analysis of the plurality of transaction data items associated with each of the proposed cryptocurrency transactions, including a combination of several of the following: (i) transaction data items pertaining to a history of previous payments associated with the proposed cryptocurrency transaction, (ii) transaction data items pertaining to previous payment instruments used by an entity associated with the proposed cryptocurrency transaction, (iii) transaction data items pertaining to a current proposed payment instrument and related transactions associated with the current payment instrument, (iv) transaction data items pertaining to a current transaction device and related transactions associated with the current transaction device, (v) transaction data items pertaining to a current user account information, (vi) transaction data items pertaining to a current electronic address, (vii) transaction data items pertaining to electronic addresses associated with a current user account, (viii) transaction data items pertaining to additional transaction devices associated with the proposed cryptocurrency transaction, (iv) transaction data items pertaining to additional electronic addresses associated with the proposed cryptocurrency transaction.

### BRIEF DESCRIPTION OF THE DRAWINGS

The detailed description refers to the following figures in which:

FIG. 1 is a block diagram illustrating an exemplary cryptocurrency exchange system according to the current disclosure.

FIG. 2 is a block diagram illustrating an exemplary API models associated with an embodiment of the current disclsosure.

FIG. 3 is a block diagram illustrating exemplary data relationships with respect to a person/entity conducting a transaction in a data table according to the current disclosure.

FIG. 4 is a block diagram illustrating exemplary data relationships with respect to a particular transaction in a data table according to the current disclosure.

FIG. 5 is a block diagram illustrating an exemplary process for reviewing a transaction according to an embodiment.

FIG. 6 is a block diagram illustrating an exemplary computing device associated with certain embodiments of the current disclosure.

FIG. 7 is a block diagram illustrating an exemplary cloud computing infrastructure associated with certain embodiments of the current disclosure.

### DETAILED DESCRIPTION

The illustrative embodiments described in the detailed description and drawings are not meant to be limiting. Other embodiments may be utilized, and other changes may be made, without departing from the spirit or scope of the subject matter presented here. It will be readily understood that the aspects of the present disclosure, as generally described herein, and illustrated in the figures, may be arranged, substituted, combined, and designed in a wide variety of different configurations, all of which are explicitly contemplated and make part of this disclosure.

Embodiments of the current disclosure take information from 1) monitoring transactions as they happen on Bitcoin and cryptocurrency exchanges; 2) KYC activities when users register on Exchanges; and 3) the Blockchain. The resulting correlation of data is then used to inform money laundering heuristics and algorithms to detect suspicious activities, that otherwise would go unnoticed when only looking at a single dimension of the transactions.

Embodiments of the current disclosure establish clear correlations between the monitored activities within and across multiple Exchanges, incorporating the data accumulated when trading cryptocurrencies from FIAT, trading cryptocurrencies to FIAT, and trading in cryptocurrency, including across different cryptocurrencies.

Embodiments of the current disclosure identify “clusters” of Bitcoin (or other currency) addresses. Clusters show transactions as statistically related through analysis of the available data associated with them, thus showing that the transactions involving those Bitcoins are related. Since transactors at exchanges make the trades, the “clusters” show that the actors and actions are related to one another, for example, monitoring of metadata from transactions (txn), KYC activities and related Blockchain data.

The clusters thus can be further used as follows: When an individual is known or suspected to be involved with Money Laundering or other forms of illegal financial activities or financial fraud, then the information that is collected through the transactions can be used to identify Bitcoins through any identified clusters: When the Bitcoins (or other cryptocurrencies) belong to a cluster, then the other individuals associated to any of those Bitcoins through the information retrieved from the exchanges may be shown to be related. Accordingly, the Bitcoin entries can be used to identify other parties potentially involved in money-laundering or other forms of illegal financial activities or financial fraud.

Similarly, if a cluster is observed, first, as potentially tied to money-laundering or other forms of illegal financial activities or financial fraud (based upon, for example, the clustering algorithms), then the transaction data and/or the KYC data can be used to map to the real people submitting the transactions in the exchanges. This establishes a correlation of attributes which are seemingly unrelated. The real people doing the transactions can then be investigated as potentially being involved with the money laundering or fraud. The attributes involved with the transactions obtained via the KYC and the submitted data can be scrutinized in all transactions as then being related to questionable activities.

In some cases, a computerized anti-money-laundering payment system may comprise software for analyzing transaction data that can identify closely related payments tabulate the amounts of transfers in a cluster of closely related payments, so that if the transfers exceed a preset limit, the system issues a warning. Further, the system execute a reputation review a flagged transaction cluster, and may then accept transactions if transaction data does not link to a known bad player, bad address, or bad phone numbers and does not exceed preset limits. Also, if the system detects association with a suspect entity, the breadth of the co-related items looked at is expanded by an additional number, and if that results in more suspicious connection, a transaction is rejected and sent for manual review.

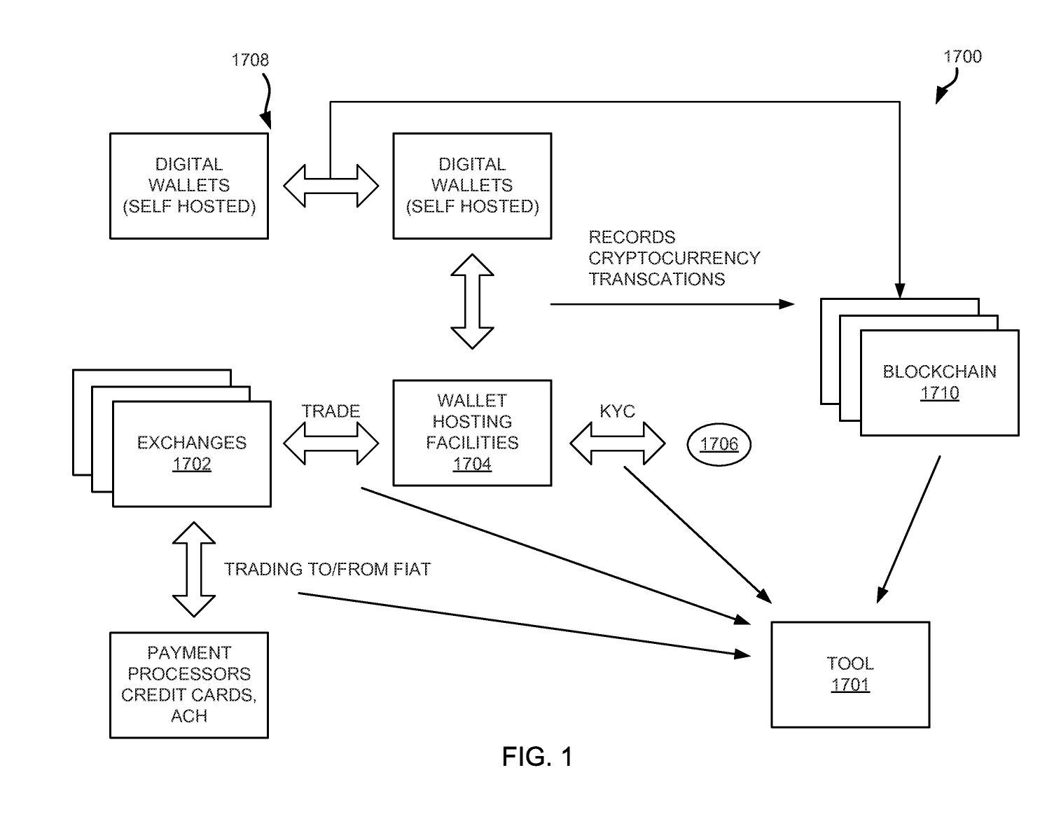

FIG. 1 illustrates an exemplary cryptocurrency exchange system 1700 operating over a computerized network (such as over a global computer network) according to the current disclosure. The system includes cryptocurrency exchanges 1702 and wallet hosting facilities 1704 for exchanging cryptocurrency into another form of currency such as FIAT currency. The system also comprises a “know your customer” facility KYC 1706 for capturing information about the users and or respectively in some cases their digital wallets 1708 of the exchange system.

As shown in FIG. 1, an exemplary cryptocurrency analysis tool 1701 models transactions associated with cryptocurrency activities occurring over a computerized network. The exemplary tool, for example, may monitor for suspicious money laundering activities (or other forms of illegal or fraudulent activities) occurring over the cryptocurrency network. In an embodiment, these transactions are monitored by contracting with some of the actors involved in these activities, and by monitoring and analyzing the public ledger—Blockchain 1710. The tool does not require full visibility across all activities, but the more information the more accurate it becomes.

The contracted actors would submit the transactions to the system through an API that enforces a model used to later correlate data across all attributes.

In addition, the information that is part of the transactions, and the information that results from aggregating and correlating this data, is used to inform analysis on the Blockchain 1710 to uncover additional correlations that aren't available to the tool because of the lack of visibility, for example, based on monitoring of metadata from transactions (“txn”) and related Blockchain data, and or clustering or correlation based on payment instrument (“PI”) metadata (Bitcoin or wallet) such as addresses and electronic DNA correlation

This correlation describes basically the users that are either the sources or destinations (or both) of the money. The description of this (these) user(s) is then much richer than what the individual entities in the ecosystem may have.

A more thorough description of the user then allows for aggregations and heuristics that would not be possible otherwise.

When the heuristics and alerts flag suspicious activities the tool issues a notification message to the AML investigators.

The computerized cryptocurrency analysis tool 1701 may include an automated payment cluster analysis routine for analyzing transaction data for a plurality of proposed cryptocurrency transactions, where each proposed cryptocurrency transaction has a transaction cryptocurrency amount. The transaction data for the plurality of proposed cryptocurrency transactions may be obtained from the cryptocurrency exchange(s) 1702, cryptocurrency ledger (such as Blockchain 1710) and/or the know-your-customer facility 1704, for example. The automated payment cluster analysis routine automatically identifies a cluster of related transactions in the plurality of proposed cryptocurrency transactions based upon an analysis of a plurality of transaction data items associated with each of the proposed cryptocurrency transactions. The computerized cryptocurrency analysis tool may also include automated summary routine for flagging a first transaction in the cluster as potentially associated with fraud and/or money-laundering as will be described below.

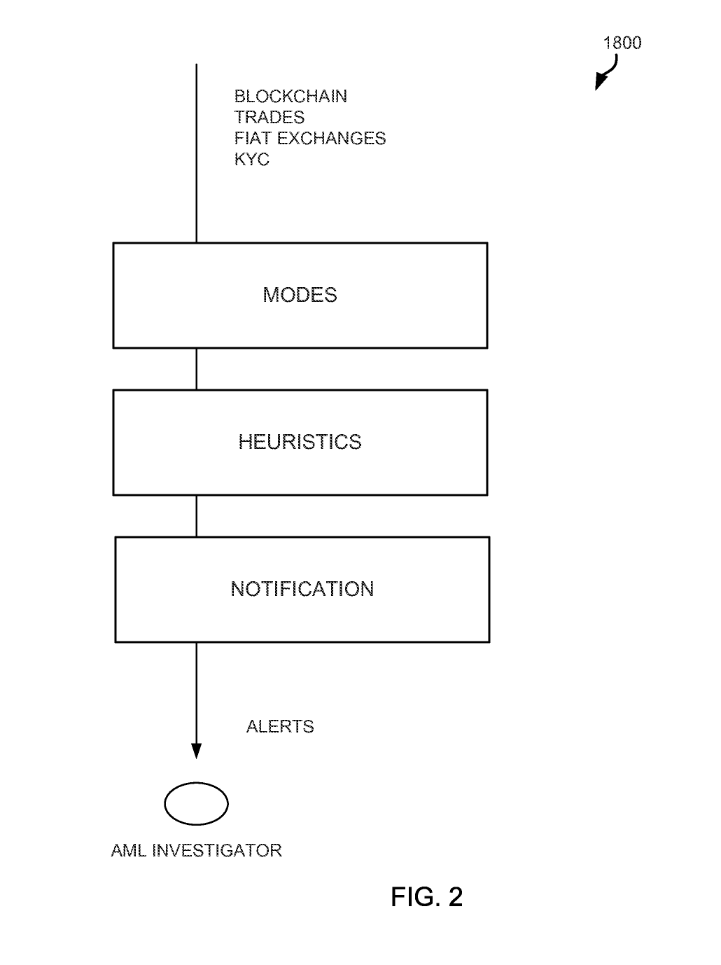

Referring to FIG. 2, example API models include, Transfer In (FIAT to crypto), Transfer Out (crypto to FIAT), Transfers (crypto to crypto), KYC and Monitoring the Blockchain.

Clustering may be monitored for the following: Monitoring of metadata from transactions(txn) and related Blockchain data; PI metadata (Bitcoin or wallet) such as addresses electronic DNA correlation.

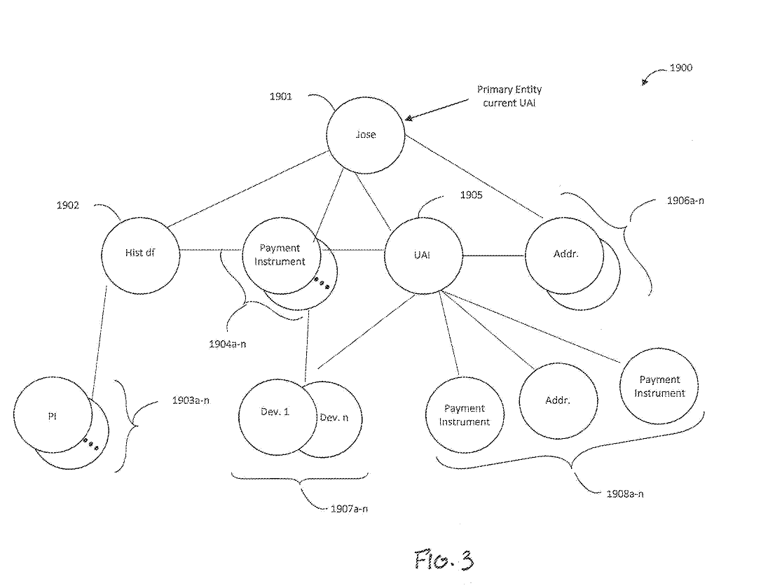

FIG. 3 shows an exemplary diagram of data relationships 1900 from which clusters of transactions can be determined to be related, according to one aspect of the system and method disclosed herein. The relationships are based on primary entity or person 1901, in this example, “Jose,” about whom the system pulls related information, including, for example, history of previous payments 1902, history of all payment instruments 1903a-n ever used by this person or entity, current payment instrument 1904a-n and transactions related to that instrument, related devices 1907a-n, related user account information (UAI) 1905, addresses ever used in conjunction with this entity 1906a-n, and any kind of additional information 1908a-n that may be somehow related to this user account. Although not necessarily related to entity 1901 or the current transaction, additional information may include, for example, additional payment instruments, addresses, etc. The system, by looking to see if any of this data may have any connection to a known bad or suspicious actor, may now link the current transaction or entity to said suspicious person, and thus by inference the current transaction or entity may be suspicious as well.

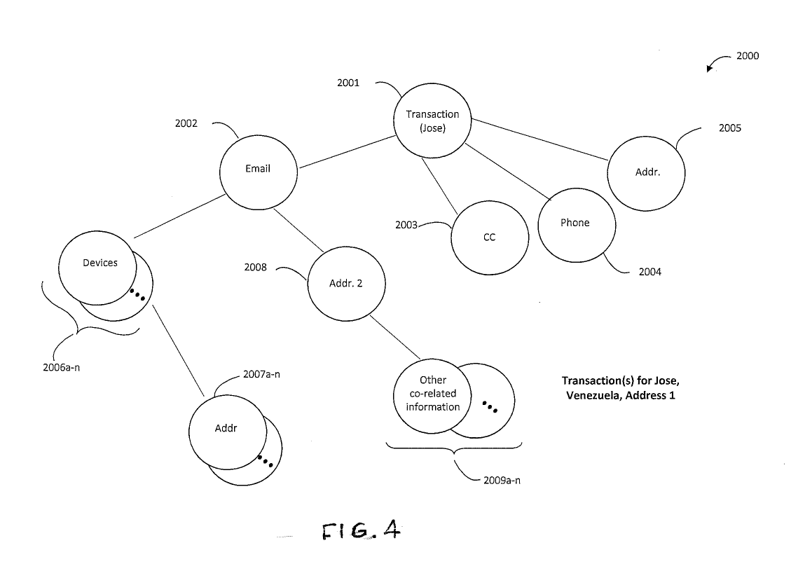

FIG. 4 shows an exemplary diagram of data relationships 2000 for a transaction itself from which clusters of transactions can be determined to be related, according to one aspect of the system and method disclosed herein. Current transaction 2001 is enacted using email 2002 and all devices 2006a-n. Sometimes a transaction may be split into multiple steps, with each step using a different device. For example, a transaction may be started on a phone and then continued on a computing device, such as a notebook or tablet. Addresses 2007a-n are addresses known to be linked to devices 2006a-n in prior transactions. Address 2008, for example, is linked to the address of email 2002, but it may be different from address 2005 given for the current transaction. Also shown is additional information such as credit card (CC) information 2003 and phone information 2004. Any other information that can be linked, directly or indirectly, to the current transaction 2001 is shown as co-related information 2009a-n. Such information may include, for example, additional addresses for the entity enacting the current transaction, from any place around the world, and any other information that could link the current transaction and its enactor to any known bad or suspicious actor.

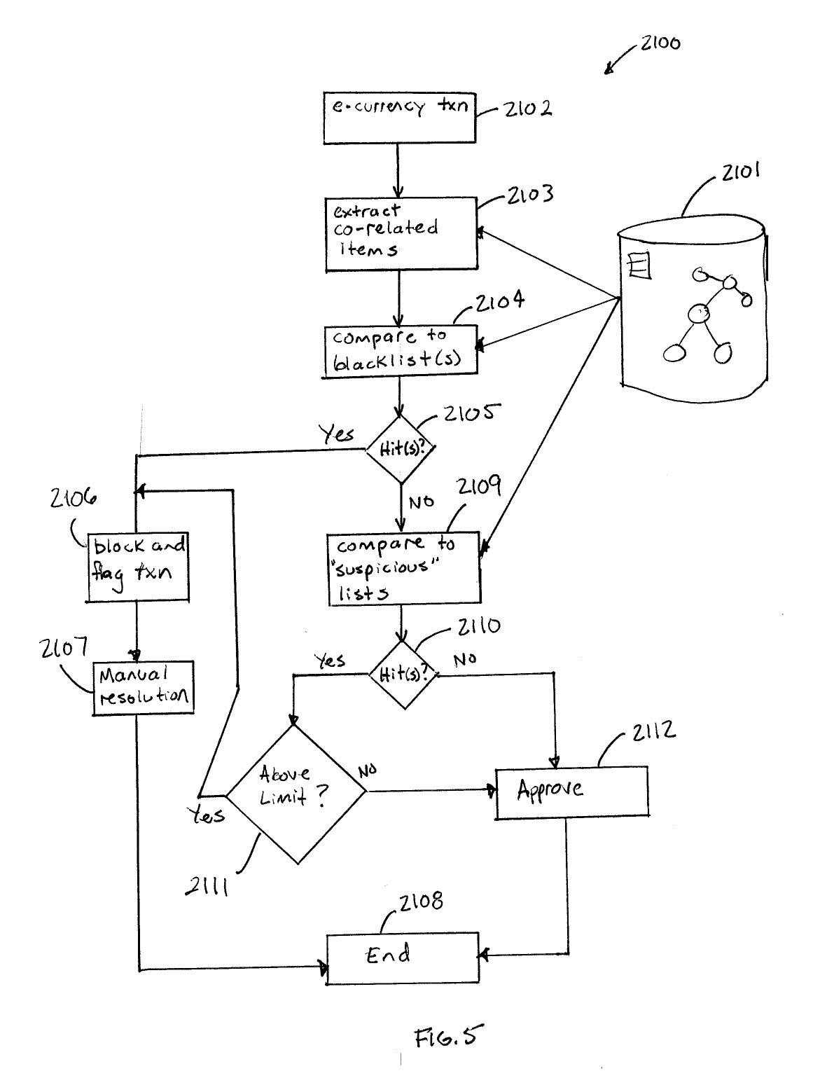

FIG. 5 shows an exemplary process 2100 for reviewing a transaction for anti-fraud, anti-money-laundering, and other related issues, according to one aspect of the system and method disclosed herein. In step 2102 an e-currency transaction is reviewed. In step 2103 co-related items are extracted from data store 2101, examples of which were described above in the discussions of FIGS. 3 and 4. These related items are typically stored in a non-SQL big database that, in this example, has a graph format; hence the data is shown as graphs in FIGS. 20 and 21. However, there is no reason the data should be limited to graphical databases; it may be stored in ordinary tables or other suitable database types (such as SQL). In step 2104 the system compares those items to known blacklists stored in data store 2101, and in step 2105 the system checks to see if any of the elements are a hit on any item(s) in any blacklist. If the system finds one or more hits (yes), the process branches to step 2106, where the transaction is blocked and flagged for review. In step 2107 the problem may be resolved by manual review. In some cases, where a transaction appears to be flagged due to only a simple mistake, a redress process, either manual or automatic, may be used. For example, if a transactor has the same name as a person on a blacklist, but no other data matches, the transactor may be issued a redress number by the relevant authorities for the affected jurisdiction(s), and using the redress number, the transactor may automatically be cleared. If the transactor has no redress number, he must apply for manual resolution. Once the manual resolution is finished, the process ends in step 2108.

If, in step 2105, the system finds no items on a known blacklist (no), in step 2109, the system compares transaction items to items on suspicious lists, also extracted from data store 2101. Suspicious lists are based on previous transactions, wherein a transactor may have some slight degree of relationship (third, fourth, or fifth degree) to a suspect, that is, a person on a blacklist, but only on a single item, so it could be not a real relationship. For example, if a transactor used a computer in a library that was previously used by a suspect, the transactor may have one common item with the suspect, namely, that specific device, but no other relationship. However, if a transactor consistently uses the same computer as a suspect, the system would assign a higher threshold of suspicion to the transactor. Further, based on a hit with a suspect entity, the breadth or depth (n links on graph from origin) of the co-related items looked at is expanded by an additional number, and if that results in more suspicious connection, a transaction is rejected and sent for manual review. So, if in step 2110, the system determines there was a hit on the suspect list (yes), then in step 2111 system checks against some predetermined limits of suspicion threshold, number of connections, and transaction value. If the number of hits is above the limit (yes), the process branches back to step 2106. If the number of hits is below the limits (no), or if in step 2110 the system determines there are no hits on the suspect list (no), the system approves the transaction in step 2112 and in step 2108 the process ends.

Various techniques may be used to correlate or cluster(ize) items in order to find reasons for approval, rejection or whether further investigation is needed. These techniques for example may include, but are not limited to, correlating attributed eDNA information or electronic signatures (such as described in U.S. application Ser. No. 12/776,784, filed May 10, 2010, the disclosure of which is incorporated herein by reference), heuristics, statistical analysis, access to third-party databases, history of transactions, level of KYC that has been performed on the user and or wallets, etc.

The illustrative embodiments described in the detailed description and drawings are not meant to be limiting. Other embodiments may be utilized, and other changes may be made, without departing from the spirit or scope of the subject matter presented here. It will be readily understood that the aspects of the present disclosure, as generally described herein, and illustrated in the figures, may be arranged, substituted, combined, and designed in a wide variety of different configurations, all of which are explicitly contemplated and make part of this disclosure.

Just as an example, recent (e.g., in last 2 to 6 months) use of a shipping address or phone number or device ID with a Bad transaction or attempt may lead the system to reject the transaction immediately. In most cases, legitimate users would contact the vendor and try to resolve the problem, thus moving that user into a higher reputation score bucket.

In some cases, a computerized anti-fraud payment system may analyze transaction data, automatically rejecting some transactions and assigning some others for manual review while others for additional automatic review, according to a set of rules, automatically accepting some of the reviewed transactions also according to rules. The review rules may accept transactions for the following reasons: Transaction uses prepaid cards and the bank has authorized the transaction; there is a history of the card being used with the consumer account, and there is no history of chargebacks or refunds; the address associated with the consumer's phone number matches the billing address associated with the payment and the consumer responds affirmatively to an automated phone call; the shipping address matches the address associated with the consumer's phone number; there is a positive, non fraud, match between the physical contact information provided in the transaction and a third-party service; and there is a positive, non fraud, match between the email contact information provided and the physical contact information for the transaction in a third-party service. Additional items may include but are not limited to such as a low transaction value, an in-depth KYC analysis has previously been performed on the user, an element of the transaction is on a whitelist, the transaction is a subscription renewal for a transaction that was previously non-fraudulent, a similar transaction, with the same suspicious characteristics, was previously manually reviewed and accepted by a human reviewer.

Further, the system may be configured to filter transactions based on transaction value and type of goods prior to acceptance rules. Additionally, the system may store a user's electronic signature associated with prior transaction(s) and compare it to the electronic signature used in the transaction currently under review, and then accept or reject the transaction depending on whether the signatures match. Other elements of comparison between past and current transactions may include a browser fingerprint, a computer fingerprint, an IP address, geographic IP location information, information associated with a payment, a typing pattern, user name, user billing address, user shipping address, user phone number, email address, or account name. The browser fingerprint may include a user agent, a screen resolution, a software plug-in, a time zone, a system language, whether Java is enabled, whether cookies are enabled, a site visited, or an IP address. Similarly, the computer fingerprint may include processor characteristic, a memory size of the machine, a value that is loaded at a key location, a value of a registry of a loaded operating system, an Ethernet MAC address, raw networking information, network information, a loaded program, or a log file. And the network information may include a network provider, whether an IP address is consistent with a known IP address, geographical proximity of an address registered with a payment instrument and the IP address as determined by an IP to geo-location service, whether or not a proxy is in use, whether a known bad IP address is in use, and whether the IP address is associated with a service provider who was associated with the user in the prior transaction.

To provide additional context for various aspects of the present invention, the following discussion is intended to provide a brief, general description of a suitable computing environment in which the various aspects of the invention may be implemented. While some exemplary embodiments of the invention relate to the general context of computer-executable instructions that may run on one or more computers, those skilled in the art will recognize that the invention also may be implemented in combination with other program modules and/or as a combination of hardware and software.

The system bus may be any of several types of bus structure that may further interconnect to a memory bus (with or without a memory controller), a peripheral bus, and a local bus using any of a variety of commercially available bus architectures. The system memory may include read only memory (ROM) and/or random access memory (RAM). A basic input/output system (BIOS) is stored in a non-volatile memory such as ROM, EPROM, EEPROM, which BIOS contains the basic routines that help to transfer information between elements within the computer, such as during start-up. The RAM may also include a high-speed RAM such as static RAM for caching data.

The computer may further include an internal hard disk drive (HDD) (e.g., EIDE, SATA), which internal hard disk drive may also be configured for external use in a suitable chassis, a magnetic floppy disk drive (FDD), (e.g., to read from or write to a removable diskette) and an optical disk drive, (e.g., reading a CD-ROM disk or, to read from or write to other high capacity optical media such as the DVD). The hard disk drive, magnetic disk drive and optical disk drive may be connected to the system bus by a hard disk drive interface, a magnetic disk drive interface and an optical drive interface, respectively. The interface for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules may be stored in the drives and RAM, including an operating system, one or more application programs, other program modules and program data. All or portions of the operating system, applications, modules, and/or data may also be cached in the RAM. It is appreciated that the invention may be implemented with various commercially available operating systems or combinations of operating systems.

It is also within the scope of the disclosure that a user may enter commands and information into the computer through one or more wired/wireless input devices, for example, a touch-screen, a keyboard and a pointing device, such as a mouse. Other input devices may include a microphone (functioning in association with appropriate language processing/recognition software as know to those of ordinary skill in the technology), an IR remote control, a joystick, a game pad, a stylus pen, or the like. These and other input devices are often connected to the processing unit through an input device interface that is coupled to the system bus, but may be connected by other interfaces, such as a parallel port, an IEEE 1394 serial port, a game port, a USB port, an IR interface, etc.

A display monitor or other type of display device may also be connected to the system bus via an interface, such as a video adapter. In addition to the monitor, a computer may include other peripheral output devices, such as speakers, printers, etc.

The computer may operate in a networked environment using logical connections via wired and/or wireless communications to one or more remote computers. The remote computer(s) may be a workstation, a server computer, a router, a personal computer, a portable computer, a personal digital assistant, a cellular device, a microprocessor-based entertainment appliance, a peer device or other common network node, and may include many or all of the elements described relative to the computer. The logical connections depicted include wired/wireless connectivity to a local area network (LAN) and/or larger networks, for example, a wide area network (WAN). Such LAN and WAN networking environments are commonplace in offices, and companies, and facilitate enterprise-wide computer networks, such as intranets, all of which may connect to a global communications network such as the Internet.

The computer may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi (such as IEEE 802.11x (a, b, g, n, etc.)) and Bluetooth.™ wireless technologies. Thus, the communication may be a predefined structure as with a conventional network or simply an ad hoc communication between at least two devices.

The system may also include one or more server(s). The server(s) may also be hardware and/or software (e.g., threads, processes, computing devices). The servers may house threads to perform transformations by employing aspects of the invention, for example. One possible communication between a client and a server may be in the form of a data packet adapted to be transmitted between two or more computer processes. The data packet may include a cookie and/or associated contextual information, for example. The system may include a communication framework (e.g., a global communication network such as the Internet) that may be employed to facilitate communications between the client(s) and the server(s).

In some cases, a computerized anti-money-laundering payment system may comprise software for analyzing transaction data that can identify closely related payments tabulate the amounts of transfers in a cluster of closely related payments, so that if the transfers exceed a preset limit, the system issues a warning. Further, the system execute a reputation review a flagged transaction cluster, and may then accept transactions if transaction data does not link to a known bad player, bad address, or bad phone numbers and does not exceed preset limits. Also, if the system detects association with a suspect entity, the breadth of the co-related items looked at is expanded by an additional number, and if that results in more suspicious connection, a transaction is rejected and sent for manual review.

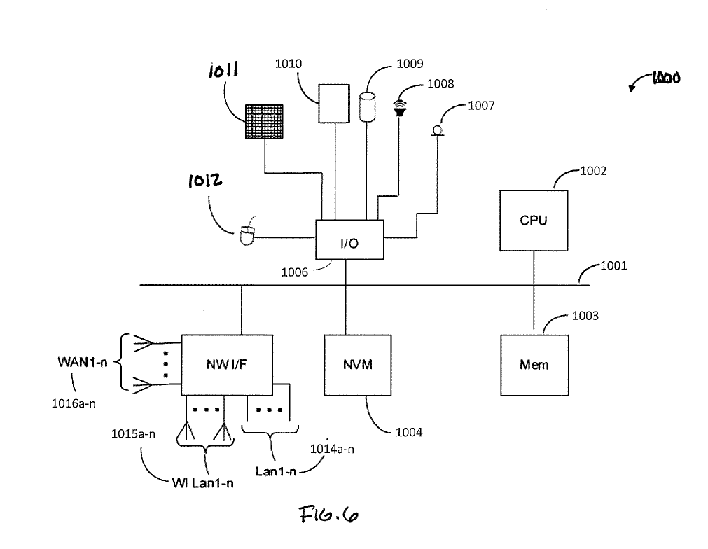

FIG. 6 shows an overview of an exemplary computing device 1000. Components comprising device 1000 include a bus 1001, CPU 1002; memory 1003; nonvolatile memory (NVM) 1004 for holding programs and start-up code, etc.; an I/O section 1006; a mass storage device 1009 that can hold additional codes such as operating systems, applications, data, etc. ; and a network interface 1013, which may accommodate any of three groups of interface types 1014a-n, 1015a-n, and 1016a-n. Wired LAN types 1-n 1014a-n may be any of various types, including, but not limited to, Ethernet, serial port, FireWire, Thunderbolt, etc. Wireless LAN types 1-n 1015a-n may be any of various types, including, but not limited to, Wi-Fi, Bluetooth, Zigbee, ultra wideband, etc. WAN types 1-n 1016a-n may be any of various types, including, but not limited to, cellular network interfaces of various different types using various different bands. Device 1000 may have a display 1010. Data input may be accomplished via a input means 1011, which may be a touch screen, a physical keyboard, or both. Pointing device 1012 could be a mouse, a touch pad, a touch screen, a joy stick, or any combinations thereof, all connected to the I/O. Other I/O devices may include a speaker 1008, a microphone 1007, a camera (not shown), etc. Computing device 1000 may be any of a wide variety of types, including, for example, a smart phone, a computer pad, a laptop, a desktop, a work station, server, etc.

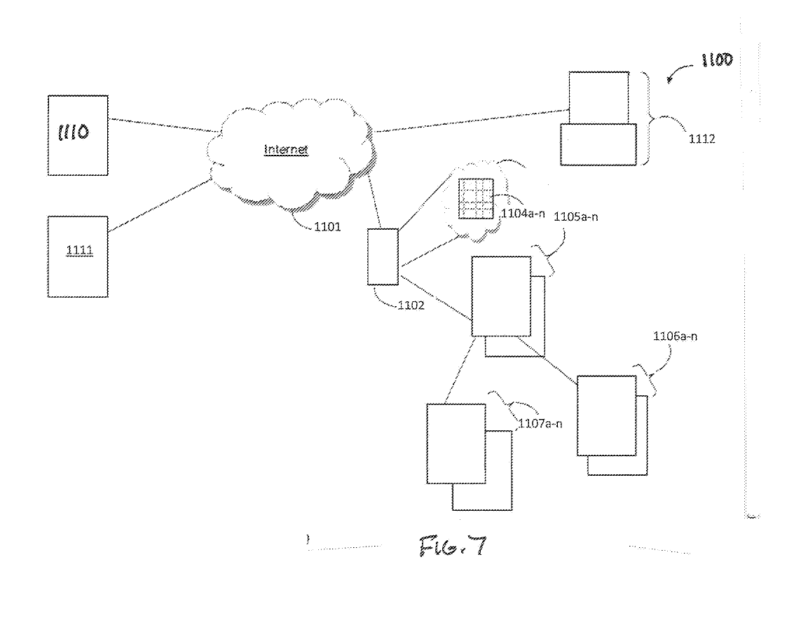

FIG. 7 shows an exemplary overview of a standard cloud computing infrastructure 1100. Server 1102 may be a single physical server or it may be a cluster 1103 of many smaller servers 1104a-n. These servers can contain multiple sets of codes 1105a-n, including multiple operating systems, on top of which may be multiple applications 1106a-n and additional multiple data sets for storage 1107a-n. Client computing devices 1110 and 1111, as well as desktop device 1112, connect to server 1102 via Internet 1101. Functionally a desktop computer is very similar to a smart phone, except that the relationship between performance and display and operating system, etc. is different, and a desktop computer has typically a much larger display. Also, in server 1102, whether a single server or a cluster, each node is just a specialized version of generic computing device 1000. Cloud computer arrangement 1100 enables applications to cooperate between one or more of the client devices and the cloud, where some functionality is performed in the cloud and some is on the device. Further, it may not always be clear what operations are being done where, and operation locations vary from situation to situation, as well as varying according the capabilities of the computing device used.

While exemplary embodiments have been set forth above for the purpose of disclosure, modifications of the disclosed embodiments as well as other embodiments thereof may occur to those skilled in the art. Accordingly, it is to be understood that the disclosure is not limited to the above precise embodiments and that changes may be made without departing from the scope. Likewise, it is to be understood that it is not necessary to meet any or all of the stated advantages or objects disclosed herein to fall within the scope of the disclosure, since inherent and/or unforeseen advantages of the may exist even though they may not have been explicitly discussed herein.

What is claimed is:

1. A computerized anti-money-laundering and anti-fraud transaction analysis system comprising:
a computerized cryptocurrency analysis tool system operatively coupled over a computerized network to at least one of a cryptocurrency exchange, a cryptocurrency exchange ledger and a know-your-customer facility;
the computerized cryptocurrency analysis tool including,
an automated payment cluster analysis routine for analyzing transaction data for a plurality of proposed cryptocurrency transactions, each proposed cryptocurrency transaction having a transaction cryptocurrency amount, the transaction data for the plurality of proposed cryptocurrency transactions being obtained from the at least one cryptocurrency exchange, cryptocurrency ledger and know-your-customer facility, the automated payment cluster analysis routine automatically identifying a cluster of related transactions in the plurality of proposed cryptocurrency transactions based upon an analysis of a plurality of transaction data items associated with each of the proposed cryptocurrency transactions; and
an automated summary routine for flagging a first transaction in the cluster of related transactions as potentially associated with at least one of fraud and money-laundering upon at least one of: (a) determining at least one of the transaction data items in the cluster of related transactions is contained on a blacklist, (b) determining that at least one of the transaction data items in the cluster of related transactions is contained on a suspicious list and a transaction cryptocurrency amount is over a predetermined threshold, (c) determining that at least one of the transaction data items in the cluster of related transactions is contained on a suspicious list and a number of connections between the cluster of related transactions is over a predetermined threshold, and (d) determining that at least one of the transaction data items in the cluster of related transactions is contained on a suspicious list and a number of cryptocurrency transfers associated with the cluster of related transactions is over a predetermined threshold.

2. The computerized anti-money-laundering and anti-fraud transaction analysis system of claim 1, wherein the automated summary routine flags a second transaction as accepted based upon at least one of (x) determining that none of the transaction data items in the cluster of related transactions is contained on either of a blacklist and a suspicious list, (b) determining that the transaction cryptocurrency amount is under a predetermined threshold, and (c) determining that the number of connections between the cluster of related transactions is under a predetermined threshold.

3. The computerized anti-money-laundering and anti-fraud transaction analysis system of claim 1, wherein the summary routine flags a third transaction for manual review upon not being flagged as potentially associated with money-laundering, upon not being flagged as potentially associated with fraud, and upon not being flagged as accepted.

4. The computerized anti-money-laundering and anti-fraud transaction analysis system of claim 1 wherein the blacklist contains at least one of known bad electronic addresses, known bad phone numbers, known bad device identifiers.

5. The computerized anti-money-laundering and anti-fraud transaction analysis system of claim 1, wherein the transaction data for the plurality of proposed cryptocurrency transactions is obtained from a combination of the cryptocurrency exchange, the cryptocurrency ledger and the know-your-customer facility.

6. The computerized anti-money-laundering and anti-fraud transaction analysis system of claim 1, wherein the transaction data for the plurality of proposed cryptocurrency transactions is obtained from a plurality of cryptocurrency exchanges.

7. The computerized anti-money-laundering and anti-fraud transaction analysis system of claim 1, wherein the automated payment cluster analysis routine automatically identifies a cluster of related transactions in the plurality of proposed cryptocurrency transactions based upon an analysis of the plurality of transaction data items associated with each of the proposed cryptocurrency transactions, including a combination of four or more of: (i) transaction data items pertaining to a history of previous payments associated with the proposed cryptocurrency transaction, (ii) transaction data items pertaining to previous payment instruments used by an entity associated with the proposed cryptocurrency transaction, (iii) transaction data items pertaining to a current proposed payment instrument and related transactions associated with the current payment instrument, (iv) transaction data items pertaining to a current transaction device and related transactions associated with the current transaction device, (v) transaction data items pertaining to a current user account information, (vi) transaction data items pertaining to a current electronic address, (vii) transaction data items pertaining to electronic addresses associated with a current user account, (viii) transaction data items pertaining to additional transaction devices associated with the proposed cryptocurrency transaction, (iv) transaction data items pertaining to additional electronic addresses associated with the proposed cryptocurrency transaction.
